(19) United States
(12) Patent Application Publication
(10) Pub. No.: US 2011/0184652 A1
(43) Pub. Date: Jul. 28, 2011

(54) METHODS OF GENERATING GENETIC PREDICTORS EMPLOYING DNA MARKERS AND QUANTITATIVE TRAIT DATA

(75) Inventors: Michael Lewis Tate, Rangiora (NZ); Peter Robin Amer, Dunedin (NZ)

(73) Assignee: Pfizer Inc., New York, NY (US)

(21) Appl. No.: 12/937,908

(22) PCT Filed: May 6, 2009
(86) PCT No.: PCT/US09/02807

§ 371 Date: Mar. 31, 2011

Related U.S. Application Data
(60) Provisional application No. 61/051,965, filed on May 9, 2008.

(51) Int. Cl. G06F 19/00

(52) U.S. Cl. 702/19

(57) ABSTRACT

A genetic trait predictor is generated by blending individual molecular estimates with estimates of at least one genetic value derived from quantitative trait measure. The individual molecular estimates may include molecular trait estimates or molecular trait variance. The individual molecular estimates may be determined by applying individual deoxyribonucleic acid (DNA) markers, DNA marker panels, specific parameter estimates and specific parameter variance thereof, and a genotype of a test sample. Quantitative trait measure may include estimated breeding data, raw trait data, and breed composition data. The genetic predictor is accurate and stable under a wide range of conditions and relatively immune to errors in parameter estimation.

### FIELD OF THE INVENTION

The present invention relates to generating genetic predictors, and particularly to methods of generating genetic predictors employing deoxyribonucleic acid (DNA) markers and quantitative trait data.

### BACKGROUND OF THE INVENTION

In the last 20 years genetic improvement has been achieved in a wide range of plant and animal species by recording of pedigree and trait data and analysis of these data to estimate the Best Linear Unbiased Predictors (BLUP) for the inherited (genetic) component of phenotypes. There are many modifications and refinements for this method.

More recently significant effort has gone into development of methods to improve genetic prediction using molecular markers. Initially this has focused on marker assisted selection (MAS) which usually involves fitting markers or linked polymorphisms (often called quantitative trait loci, QTL) as fixed or random effects in the BLUP analysis. The most recent development in the area is genome-wide MAS or genomic selection in which a large number of markers are genotyped (e.g. 60,000) simultaneously. Iterative sampling methods are used to create a SNP key predictor of genetic performance.

The key drawbacks of these approaches are as follows

(1) Quantitative measures: to estimate genetic or breeding value using BLUP typically animals need to have pedigree and trait records and to reasonably compare animals across environments/groups they need to be genetically linked to one another. This greatly limits the scope of genetic predictors to groups of animals where intensive recording is practical and there are genetic linkages (e.g. common sires) linking different animals in different groups and environmental conditions. A further drawback of most Quantitative estimates is that the estimates only become accurate once an animal has a large number of progeny, and so are typically of low to intermediate accuracy in young animals, except for highly heritable traits. Another drawback of many BLUP systems is they provide only for within breed comparisons because of a lack of suitable phenotypic data structure with breeds and crosses being reared in the same environments. While there are breed comparison experiments, and some across breed genetic evaluation systems around the world, there are many problems also with genotype by environment interactions

(2) MAS; while theoretically workable, MAS shares many of the same problematic issues as (1) above and in addition marker assisted selection (MAS) has proved difficult to implement in practice. One of the reasons for this is that, in practice, there is significant missing genotype and/or phenotype data. Methods such as genotype inference can allow for some missing genotype data. MAS has been used successfully in individual large well managed breeding schemes but problems with parameter estimation and very sparse genotype data have meant it has been very difficult to implement MAS in genetic breeding value services to pastoral animal industries.

(3) Genomic selection appears to provide a robust predictor that can be applied without quantitative information but (1) the very large numbers of markers needed for genomic selection are currently expensive and (2) the SNP key generated tends to only be relevant to animals from the same breed/population, unless density is very high. The power of SNP key predictors drops rapidly as they are applied in different populations.

In view of the above, there exists a need for methods of generating genetic predictors that are accurate and stable under a wide range of conditions and can be compare across breeds and breed composites.

Further, there exists a need for methods of generating such genetic predictors that are relatively immune to errors in parameter estimation.

### SUMMARY OF THE INVENTION

The present invention addresses the needs described above by providing methods of generating genetic predictors based on DNA markers and quantitative trait data.

In the present invention, a genetic predictor is generated by blending molecular estimates of merit with estimates of at least one genetic value derived from a quantitative trait measure. The individual molecular estimates may include molecular trait estimates or molecular trait variance. The individual molecular estimates may be determined by applying individual deoxyribonucleic acid (DNA) markers, DNA marker panels, specific parameter estimates and specific parameter variance thereof, and a genotype of a test sample. Quantitative trait measures may include estimated breeding values, raw trait data, and breed composition data recorded from the knowledge of an animals ancestry, and the breed status of ancestors. The genetic predictor of the present invention is informative and useful under a wide range of conditions and relatively immune to errors in parameter estimation for above zero parameter values.

According to an aspect of the present invention, a method of generating a genetic trait predictor for an animal or plant species is provided, which comprises:

generating individual molecular estimates; and

blending said individual molecular estimates with estimates of at least one genetic value derived from quantitative trait measure wherein said genetic predictor is correlated to a trait measured by said quantitative trait measure.

In one aspect, individual molecular estimates are generated by analysis of reference datasets from different populations of animals to derive parameters for individual DNA markers or DNA marker panels describing the decay or change of marker effects on specific traits with genetic distance.

In another aspect, individual molecular estimates are generated by calculation of the genetic distance between a test sample and reference validation datasets by comparing DNA marker information from the test sample and reference dataset. In a further aspect, in simple cases, breed type or percentage of breed type in a crossbred animal can be used as a surrogate for genetic distance. In this case, the breed composition of the animal may be calculated from the molecular data and individual marker effects appropriate to the identified breed(s) used proportionately to generate individual molecular estimates. Alternatively, breed composition may have been identified through knowledge of breed composition of parents.

In another aspect, the methods are used to more accurately and simply to provide estimation of the relative genetic merit of animals from different breeds and breed mixtures. In this case the breed composition of an animal is estimated by comparison of the animals genotype to breed reference populations and the breed composition is used to (1) derive the appropriate baseline performance of the animal (e.g. in a crossbreed the weighted average performance of the breeds for the trait) and (2) the appropriate breed specific blending parameters are calculated as described above.

Individual molecular estimates are generated by using the genetic distance between the test sample and the reference samples and the parameters calculated above to derive specific parameter estimates and a variance for each individual marker/marker panel for the test sample. Then the individual/marker/trait-specific parameters and the genotype of the test sample are applied to a blending algorithm which calculates molecular trait estimates and variance which can be used to estimate the genetic merit of any animal. In one aspect, genetic merit is feedlot marbling. However this can be applied to any estimation of the genetic merit of any trait where there is a molecular predictor and the potential to collect phenotypic data relevant to the trait. This includes reproductive traits such as, age at puberty, weight at puberty, fertility, prolificacy, calving interval, return rates to artificial insemination, gestation length, birthing difficulty, embryo or neonate survival, mothering ability; milk traits, such as volume, protein and fat percentage and composition, somatic cell count, lactation curve shape; growth and carcass composition traits such as birth weight, weaning weight, yearling weight, adult weight, slaughter weight, carcass weight, pre- and post-weaning average daily gain, carcass muscle and fat and bone ratio and location or distribution in the carcass, disease resistance and immune traits such as response to internal and external parasites, bacterial, viral or prion disease; metabolic traits such as resistance to toxins, feed efficiency, carbon emissions; physical traits such as deformities, foot structure, breed defining characteristics, color patterns, presence of horns; fibre traits such as fibre yield, fibre diameter, fibre curvature, fibre strength, fibre colour, fibre bulk; behavioural traits such as flight distance, aggressiveness, docility, mothering ability; meat quality traits, such as tenderness, quality grade, color, color stability, muscle shape, cut shape, marbling, metabolite or fat quality and content; biochemical or gene expression traits such as the amount or RNA or specific gene products in a tissue samples.

In yet another aspect, individual molecular estimates are blended with estimates of genetic value derived from quantitative trait measures using equations provided herein.

In still another aspect, estimates of genetic value derived from quantitative trait measures can include estimated breeding values, raw trait data or breed composition data (derived from visual, pedigree or DNA marker information).

### BRIEF DESCRIPTION OF THE DRAWINGS

FIG. 1 is a flow diagram illustrating the steps employed to generate a genetic predictor according to the present invention.

### DETAILED DESCRIPTION OF THE INVENTION

As stated above, the present invention relates to methods of generating genetic predictors employing deoxyribonucleic acid (DNA) markers and quantitative trait data, which are now described in detail. As used herein, when introducing elements of the present invention or the preferred embodiments thereof, the articles “a”, “an”, “the” and “said” are intended to mean that there are one or more of the elements.

Definitions. The following definitions are provided in order to assist the quantitative or molecular geneticist or animal breeder of ordinary skill in the art to more easily and fully appreciate the instant invention. The definitions provided herein are not intended to be exclusive, but instead are provided as preferred definitions, intended to assist the skilled artisan in understanding the present invention. By “allele” is meant a particular version or variant of a specific gene. By “animals” is meant all animals such as livestock including but not limited to cows, sheep, pigs, aquaculture species including but not limited to fish mollusks and crustaceans and domestic animals such as dogs, cats and horses. By “blended index” is meant the combination of a marker score xₘ and the multi-trait BLUP estimated breeding value for a goal trait (Iᵣ) as represented by the formula (I_{b}).

I≈I_{b}=γ·Iₘ+β·Iᵣ

where γ and β are blending correction factors. By “BLUP” is meant an acronym for best linear unbiased prediction and refers to a statistical methodology introduced by Henderson (1959-HENDERSON, C. R.; KEMPTHORNE, O.; SEARLE, S. R.; VON KROSIGK, Biometrics 1959 13 192-218) that has become an animal breeding industry standard for predicting breeding values for individual animals. Common input parameters for BLUP programs and algorithms known in the art include genetic and phenotypic parameter estimates, phenotypes, pedigrees and fixed effects. By “breeding value” is meant the true value of an animal as a parent for a defined trait or performance characteristic. It is also understood in connection with the present invention as a measure of the animal's net breeding value. By “performance traits” means a group of traits that can define in a quantitative way desirable and/or undesirable attributes of farmed livestock. Examples of such traits include but are not limited to: average daily gain, average daily feed intake, feed efficiency, back fat thickness, loin muscle area, and lean percentage By “estimated breeding values” (EBV) is meant a specific numeric value for an animal that predicts its “breeding value”. By “DNA markers” or “DNA marker panels” is meant genetic markers associated with various animal traits such as but not limited to marbling, intramuscular fat, tenderness, milk production and the like. Markers are sequences of DNA that have a specific location on a chromosome that can be measured in a laboratory. Markers contemplated by the present invention include, but are not limited to: RFLP (restriction fragment length polymorphism), SSR (simple sequence repeat or microsatellite marker) and SNP (single nucleotide polymorphism). By “genetic distance” is meant a measure related to the evolutionary genetic distance between two populations, ideally this should accurately measure the number of meioses between two individuals (or average number of meioses between two populations) and their nearest common ancestor. By “genetic merit” is meant the value of an animal under consideration for selection as a breeding parent for contributing to an improved level of performance in a trait in future generations of genetic descendants. In one embodiment, the greater the genetic merit of an animal for a given trait, the more likely it is to provide offspring having an improved level of performance in that trait. By “fixed effects” means seasonal, spatial, geographic, or environmental influences that cause a systematic effect on the phenotype. By “herd” and “population” is meant any group of breeding animals having a sufficient number of animals for the effective use of the present invention. The terms may apply to animals such as swine, cattle, goats, fish or any other animal that is raised commercially, including, but not limited to fowl or any other species where it is desirable, for any reason, to analyze one or more traits before choosing breeding animals to generate future generations of descendants as part of a genetic improvement program. Animals can also include domestic animals, such as dogs, cats and horses, for example. By “locus” is meat a specific location on a chromosome (e.g. where a gene or DNA marker is located). By “polymorphism” is meant the variation that exists in the DNA sequence for a specific marker or gene. By “quantitative trait” is meant a trait that is controlled by a large number of genes each of a small to moderate effect. The observations on quantitative traits generally follow a normal distribution. The term “quantitative trait locus (QTL)” means a locus that contains polymorphism(s) that have an effect on a quantitative trait. A “selection index” refers to a weighted sum of EBVs for different economic traits.

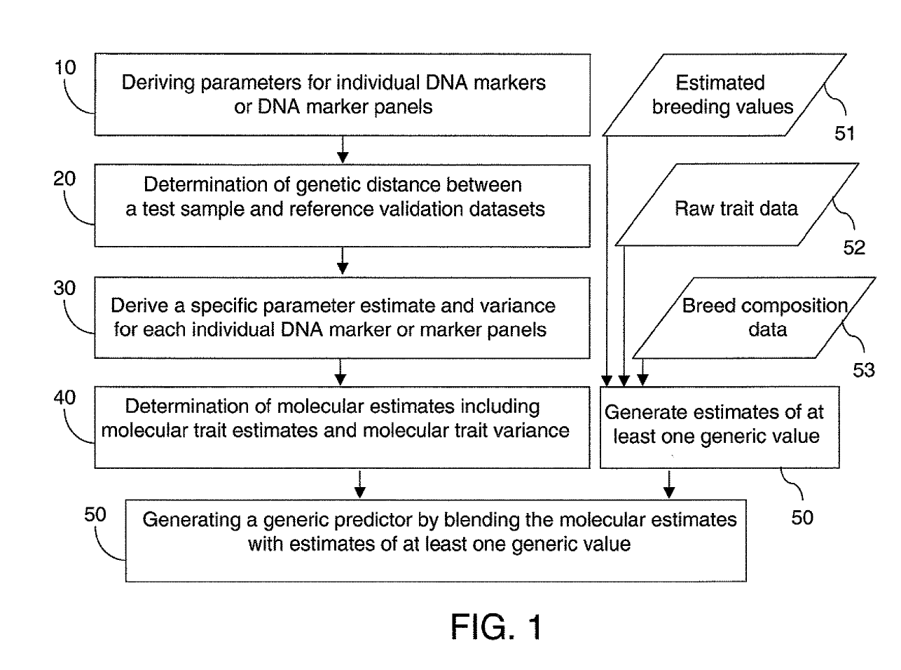

Referring to FIG. 1, a flow diagram illustrating the steps employed to generate a genetic predictor according to the present invention is shown.

Referring to step 10, datasets from different populations of animals are analyzed to derive parameters for individual DNA markers or DNA marker panels describing the decay or change of marker effects on specific traits with genetic distance.

Referring to step 20, genetic distance between a test sample and reference validation datasets is calculated by comparing DNA marker information from the test sample and the reference dataset. Optionally, breed type composition can be used as a surrogate for genetic distance.

Referring to step 30, a specific parameter estimate and variance for each individual DNA marker or marker panel is calculated using the genetic distance between the test sample and the reference samples [step 20] and the parameters calculated in step 10.

Referring to step 40, molecular estimates are calculated by application of individual/marker/trait-specific parameters and the genotype of the test sample

Referring to step 50, estimates of at least one genetic value are derived from the quantitative trait measure. Non-limiting examples of the quantitative trait measure include estimated breeding values 51, raw trait data 52, and breeding composition data 53. The quantitative trait measure may be at least one of the estimated breeding values 51, the raw trait data 52, and the breeding composition data 53. The quantitative trait measure may be a combination of at least two of the estimated breeding values 51, the raw trait data 52, and the breeding composition data 53. The quantitative trait measure may be the estimated breeding values 51, the raw trait data 52, and the breeding composition data 53. Quantitative trait measures or measurements include raw trait data generated by field observations, reproductive status or animal behavior, color and conformation; weight or length of an organism or parts of an organism at various times; body composition measures such as lean, fat distribution determined by scanning with sound (ultra-sound) or electromagnetic radiation (x-ray, near infra-red) or direct measurement; assays of immune or metabolic or gene expression status taken from tissue samples; meat quality measures taken mechanically, such as shear force, chemically such as fat composition, or by consumer taste panels.

### EXAMPLES

### A. Selection Index Theory

i. General

In accordance with the present invention, the standard selection index for comparing the performance of a set of selection candidates for a single trait affecting profit (referred to subsequently as the goal trait) is defined as

I=b′x

where I is the index value for a selection candidate, b is a set of optimal index weights applying to i different sources of recorded information (x) on the selection candidate and/or its relatives. For this situation where the selection index is used to predict merit for a single goal trait, values of/for each candidate can be interpreted as estimated breeding values (EBV) for the profit trait. The optimal index weights which maximise the correlation between/and some unknown true genetic values for the goal trait, and which also result in a regression of 1 for the true genetic values on the index values, are computed as

b=P⁻¹g

where P is a phenotypic variance covariance matrix for recorded information sources and g is a vector giving the genetic covariance's between each recorded information source and the goal trait.

When one of the recorded information sources is a genetic marker score, one can partition the P matrix and the g vector to distinguish between selection index weights for recorded phenotypic traits (subscript r), and the weighting placed on the genetic marker score (subscript m) as follows;

$$[ \begin{matrix}{b}_{r} \\ {b}_{m}\end{matrix} ] = {[ \begin{matrix}{P}_{rr} & {p}_{r}^{′} \\ {p}_{r} & {p}^{2}\end{matrix} ]}^{- 1} [ \begin{matrix}{g}_{r} \\ {g}_{m}\end{matrix} ]$$

where p² denotes the phenotypic variance of the marker score, which is expected to be very similar to the genetic variance of the marker score, because the heritability of a marker score is expected to be close to 1 unless genotyping errors are prevalent.

An alternative index formulation would be to use marker information, and recorded trait information independently to predict the desired goal trait. In this way, one can define selection index weights as

$${b}_{m}^{*} = \frac{{g}_{m}}{{p}^{2}}$$

$$and$$

$${b}_{r}^{*} = {P}_{rr}^{- 1} {g}_{r} .$$

With this formulation the index Iᵣ=bᵣ*′xᵣ would correspond to the multi-trait BLUP estimated breeding value for the goal trait where the estimation procedure uses phenotypes only and no marker information.

A new and surprisingly more robust and accurate index can be formulated, which will subsequently be referred to as a “blended index”, and which combines the marker score xₘ and the multi-trait BLUP estimated breeding value for a goal trait (Iᵣ). However, it is not appropriate to simply add Iᵣ and the stand alone marker index value Iₘ=bₘ*xₘ because no account would be taken for the double counting of variation in the goal trait which can be jointly explained by the marker score and the multi-trait BLUP estimated breeding value for the goal trait. Instead, the blended index (I_{b}) needs to be defined as

I≈I_{b}=γ·Iₘ+β·Iᵣ

where γ and β are blending correction factors. Values for γ and β that result in I_{b} having a high correlation with the true breeding values for the goal trait and an expected regression of true breeding values for the goal trait on I_{b} of 1 can be computed as

$$γ = \frac{{b}_{m}}{{b}_{m}^{*}} and β = f ( \frac{{b}_{r 1}}{{b}_{r 1}^{*}} , \frac{{b}_{r 2}}{{b}_{r 2}} … \frac{{b}_{rn}}{{b}_{rn}^{*}} )$$

where f is a function that takes a weighted average of ratios of corresponding pair of elements from bᵣ* and bᵣ where the weightings used depend on the strength of the correlation between each recorded trait and the goal trait.

ii. Single Recorded Trait

For a situation where there is just one recorded predictor trait (r₁) which has a much higher correlation with the goal trait than other recorded traits, then one has the simple case of

$${P}_{rr} = scalar = f ( \frac{1}{{acuracy}^{2}} ) .$$

where b_{r1.g} is the genetic regression of the goal trait on the recorded trait.

If a single recorded trait is the primary source of information to predict the goal trait BLUP estimated breeding value, the computation of β can be further simplified by defining a phantom variable corresponding to the recorded trait which is only measured on the selection candidate with repeated measures.

The phenotypic variance of this phantom variable can be defined as a function of the accuracy of the multi-trait BLUP estimated breeding value for the goal trait (I_{b}). In this case

$$β = \frac{{b}_{r 1}}{{b}_{r 1}^{*}} {b}_{r 1. g}$$

iii. Recorded Trait Equals Goal Trait

In the special case whereby the recorded trait is the same as the goal trait (i.e. genetic correlation of 1 and equal variances), the above method is analogous to methods originally proposed by Neimann-Sorensen and Robertson (1961). The association between blood groups and several production characteristics in three Danish cattle breeds. Acta Agriculturae Scandinavica Vol. 11 (163-196).

### B. Parameterisation for a Single Recorded Trait

In this section, the theoretical approach described above is parameterized for the special case situation whereby a goal trait of interest is predicted jointly by a genetic marker score, and by an estimated breeding value for a single recorded trait, i.e. a blended index

i. Derivation of Blending Correction Factors

A recorded trait (a) is defined which for any individual has an estimated breeding value â which has been evaluated such that the correlation between â and the animal's true breeding value for the same recorded trait is r_{â,a} (the selection accuracy). Animals also have a true breeding value for a trait denoted by A with direct economic benefit. The phenotypic variances of A and a and their phenotypic covariance are denoted σ²A, σ²a and σAa respectively. Genetic variances and covariances are denoted h²A·σ²A, h²a·σ²a and rG_{A,a}·√h²A·h²a·σAa where h² denotes trait heritability and rG denotes the genetic correlation. In addition, let M be a marker score which has a heritability of 1 and which has a variance equal to rG_{A,M}²·σ²A where rG_{A,M} is the genetic correlation between the marker score and the trait with direct economic benefit and rG_{A,M}² gives the proportion of genetic variance in trait A that can be explained by the markers. With this definition, the marker score for any selection candidate would have been computed using, for example,

$${M}_{i} = α {\sum }_{m} {β}_{m} {θ}_{im}$$

where βₘ, are unbiased estimates of regression coefficients on trait A associated with m marker genotypes θᵢₘ for the ith selection candidate and α is a scaling constant (less than 1) which accounts for sampling errors in estimates of β's inflating the ratio of variance of M to variance of trait A (e.g. Smith, 1967 Improvement of metric traits through specific genetic loci. Animal Production 9:349-358). Genetic and phenotypic covariances for the recorded trait, and the economic benefit trait with the marker score are denoted σMa, σMA, rG_{M,a}·√h²M·h²a·σMa and rG_{A,M}²·σ²A respectively.

Selection index formulae can be simplified by assuming that traits have been standardised by dividing through by the phenotypic standard deviation. When one computes the blending correction factors contemplated by the present invention (γ and β), the trait variances effectively cancel out in the computation of the ratios of index weights, so it is convenient to use variances and covariances of standardised variables. Thus, σ²a and σ²A take values of 1 and drop out of the variable definitions described above.

With this parameterisation, applied to the equations defined in section A (above) one can solve;

$$[ \begin{matrix}{b}_{r} \\ {b}_{m}\end{matrix} ] = {[ \begin{matrix}{P}_{rr} & {p}_{r}^{′} \\ {p}_{r} & {p}^{2}\end{matrix} ]}^{- 1} [ \begin{matrix}{g}_{r} \\ {g}_{m}\end{matrix} ]$$

represented in scalar algebraic form by

$$[ \begin{matrix}{b}_{r} \\ {b}_{m}\end{matrix} ] = {[ \begin{matrix}e & b \\ b & 1\end{matrix} ]}^{- 1} [ \begin{matrix}c \\ d\end{matrix} ]$$

to get

$${b}_{r} = \frac{b \cdot d - c}{{b}^{2} - e} and {b}_{m} = \frac{b \cdot c - g \cdot d}{{b}^{2} - e}$$

where b=rG_{M,a}\sqrt{hₐ²h_{M}²}, c=rG_{A,a}\sqrt{hₐ²h_{A}²}, d=rG_{M,A}\sqrt{h_{A}²h_{M}²} and

$$e = {rG}_{a , A}^{2} {h}_{a}^{2} \frac{1}{{acc}_{Recorded}^{2}}$$

with acc_{Recorded} being the accuracy of the BLUP prediction of a recorded trait estimated breeding value that acts as a predictor for the goal trait estimated breeding value. The index weights when marker and phenotype information sources are considered independently are

$${b}_{m}^{*} = d and {b}_{r}^{*} = \frac{c}{e} .$$

In this case,

$$γ = \frac{{b}_{m}}{{b}_{m}^{*}} and β = \frac{{b}_{r}}{{b}_{r}^{*}}$$

and the blended estimated breeding value for the goal trait is then

EBV_{Blended}=γ·EBVₘₐᵣₖₑᵣ+β·EBV_{Recorded}·φ

where

$$φ = \frac{{rG}_{A , a} \sqrt{{h}_{a}^{2} {h}_{A}^{2}} {σ}_{a} {σ}_{A}}{{h}_{a}^{2} {σ}_{a}^{2}} = \frac{{rG}_{A , a} \sqrt{{h}_{A}^{2}} {σ}_{A}}{\sqrt{{h}_{a}^{2}} {σ}_{a}}$$

which denotes the genetic regression of the goal trait on the recorded trait. EBV_{Marker} needs to be expressed as a genetic predictor of the true breeding value of the goal trait. EBV_{Recorded} is the estimated breeding value of the correlated recorded trait, which has been estimated with accuracy acc_{Recorded} and because the blending correction factors are a function of acc_{Recorded}, γ and β need to be computed specifically for each selection candidate unless acc_{Recorded} is constant across all selection candidates with marker information.

ii. Accuracy of Blended Breeding Value

The accuracy of EBV_{Blended} for the situation of a single recorded trait can be computed as

acc_{Blended}=\sqrt{rG_{M,A}²·γ+acc_{Recorded}²·β·rG_{a,A}²}.

iii. Sensitivity to Errors in Parameters

Errors in parameters used to formulate selection indexes are well known to affect the accuracy of prediction of estimated breeding values, to affect the efficiency of selection, and to cause over-predictions of the benefits of selection, although it usually takes quite large errors to occur before significant reductions in efficiency occur (Sales, J. and Hill, W. G. 1976a. Effects of sampling error on efficiency of selection indexes.1. Use of information from relatives for single trait improvement. Animal Production 22:1-17); Sales, J. and Hill, W. G. 1976b. Effects of sampling error on efficiency of selection indexes.2. Use of information on associated traits for improvement of a single important trait. Animal Production 23:1-14). Sensitivity can be tested by simulating true breeding values for the goal trait along with estimated breeding values from phenotypes and estimated breeding values from marker information based on a specified set of parameters. The accuracy of the blending method when correctly parameterised using the same parameters as used in the simulation can then be compared with predictions using blending correction coefficients that have been derived using incorrect parameters.

Sensitivity testing has revealed that the blending approach is very robust to the estimate of the genetic correlation between the marker score and the EBV trait. That is because this correlation acts relatively evenly on both the marker blending coefficient, and the EBV blending coefficients. The approach is also robust (<2% loss) to errors in marker prediction accuracy of +/−50%. In general, the effects of errors in parameters associated with estimates of marker effects are comparable to errors associated with the estimation of the genetic correlations of recorded traits with profit traits.

### C. Example Implementation for Feedlot Marbling Markers

An example of how the method of the present invention can be implemented is provided here for a set of 4 markers (M1-M4) that have been associated with feedlot marbling traits. In conventional breeding programmes, genetic merit for feedlot marbling is predicted using estimated breeding values for intramuscular fat percentage (IMF %). A disadvantage of EBVs for intramuscular fat is that they tend to be recorded on young male selection candidates who are being evaluated for sale or for retention as an elite sire within the breeding herd. Literature estimates of relevant genetic parameters suggests that IMF % breeding values recorded in young bulls may not consistently provide accurate rankings of young bulls' genetic merit for feedlot marbling ability.

i. Estimating Genestar Marbling Effects on Genotypes

The inventors were initially presented with 6 Australian datasets with marbling information and Genestar marbling results, plus, estimates of individual marbling effects and their standard errors and probabilities were available for a US validation dataset. 4 of the Australian datasets were rejected on the grounds of having either too few animals with phenotypes and genotypes, or because of poor spread in carcass marbling scores. For example, in these 4 rejected datasets, the two most frequent marbling score categories accounted for 92%, 87%, 84% and 76% of all animals, with minimal animals outside of the third most frequent category. In contrast, in the two retained datasets, the most frequent category had less than 30% of the animals, and there was a span of 7 marbling score categories with each category within the span having a minimum of 5% of all animals.

The two Australian datasets that were retained were then used to compute expected marker affects, and the US dataset was also used to investigate whether or not there was meaningful evidence of one or more of the marbling Genestar markers having more significant affects than the others.

In each dataset, there were no statistically significant estimates of dominance, and so alleles have subsequently assumed to be additive at each of the 4 loci. Allele effects and their standard errors were estimated using Least Squares—General Linear Models (PROC GLM in SAS) procedures where the number of favorable alleles at each locus were simultaneously fit as covariates (independent variables) with marbling score as the dependant variables. Equivalent marker estimates from the US dataset were taken directly from the website source.

Pseudo-heritabilities were computed for each loci effect per allele. These heritabilities were computed for the two Australian data sets as

h²(marker effect)=[estimate²−(standard error of estimate)²]/estimate²

In order to standardise scales, the marker effects were then transformed to be expressed as a proportional size relative to the largest marker effect within the dataset. Weighted average standardised marker effects were then computed across the three datasets using the heritabilities as a weighting factor. Thus, when a dataset has a low estimate heritability for a particular marker, that dataset contributes less to the overall estimate than a dataset with a high heritability for that marker. The resulting average standardised allele affects were 0.58, 0.79, 0.84 and 0.71 and so it was concluded that there was insufficient evidence across the three datasets to predict different allele effects for the different marker loci. For the two Australian datasets, the average favorable allele affect estimate was approximately 0.5, and the average standardised effect was 0.74. Thus, 0.37 was taken as the average effect of a favorable Genestar marketing allele on Australian carcass marbling score.

TABLE 1
Summary of allele effect estimates from Marbling datasets

| | | |
|---|---|---|
| Aust. Dataset 1 | Aust Dataset 2 | US Dataset¹ |

Marbling score frequencies

| | | | |
|---|---|---|---|
| 0 | 0.011 | 0.000 | N/A |
| 1 | 0.085 | 0.000 | N/A |
| 2 | 0.252 | 0.067 | N/A |
| 3 | 0.176 | 0.216 | N/A |
| 4 | 0.188 | 0.298 | N/A |
| 5 | 0.110 | 0.157 | N/A |
| 6 | 0.057 | 0.078 | N/A |
| 7 | 0.051 | 0.071 | N/A |
| 8 | 0.036 | 0.078 | N/A |
| 9 | 0.035 | 0.035 | N/A |

SNP favorable allele frequencies and effects estimates

| | | | | |
|---|---|---|---|---|
| M1 | 0 copies | 0.45 | 0.48 | 0.66 |
| | 1 copy | 0.44 | 0.40 | 0.30 |
| | 2 copies | 0.10 | 0.13 | 0.05 |
| | Beta | 0.46 | 0.14 | 7.7 |
| | SE Beta | 0.09 | 0.17 | 5.7 |
| | p | 0.001 | 0.392 | 0.18 |
| | h2 | 0.97 | 0 | 0.45 |
| M2 | 0 copies | 0.43 | 0.20 | 0.70 |
| | 1 copy | 0.40 | 0.52 | 0.26 |
| | 2 copies | 0.17 | 0.28 | 0.04 |
| | Beta | 1.16 | 0.26 | 2.8 |
| | SE Beta | 0.08 | 0.17 | 6.6 |
| | p | 0.001 | 0.133 | 0.68 |
| | h2 | 0.99 | 0.54 | 0 |
| M3 | 0 copies | 0.78 | 0.84 | 0.90 |
| | 1 copy | 0.21 | 0.15 | 0.09 |
| | 2 copies | 0.02 | 0.01 | 0.01 |
| | Beta | 0.23 | 0.67 | 6.4 |
| | SE Beta | 0.13 | 0.29 | 10 |
| | p | 0.07 | 0.023 | 0.52 |
| | h2 | 0.19 | 0.80 | 0 |
| M4 | 0 copies | 0.47 | 0.44 | 0.53 |
| | 1 copy | 0.43 | 0.47 | 0.40 |
| | 2 copies | 0.10 | 0.09 | 0.07 |
| | Beta | 0.25 | 0.67 | 7.9 |
| | SE Beta | 0.09 | 0.18 | 5 |
| | p | 0.006 | 0.004 | 0.11 |
| | h2 | 0.89 | 0.92 | 0.60 |

¹Results from the US data set were sourced from the internet (http://www.nbcec.org/nbcec/index.html)

The US data set is directly available from the National Beef Cattle Evaluation Consortium (NBCEC) as sponsored by Colorado State University, Cornell University, and the University of Georgia. In connection with the genetic test validation webpages and commercial genetic test validations that

ii. Parameters Used for Blending Genestar Marbling Star Scores with IMF % Breeding Values

The following assumptions were made when building the parameter sets required to construct blending formulae as outlined above Please note our response to the comment;
that the genetic correlation between IMF % the trait defining the relevant Breedplan EBVs and commercial feedlot Australian Marbling Score (AusMS) is 1, in other words, they are the same trait, such that if IMF % was predicted perfectly, then AusMS would be predicted perfectly. Even though Breedplan IMF % BVs are based on measurements of relatively young animals, they are translated into a slaughter age equivalent. Nevertheless, AusMS may well be a different trait to IMF %, even at the same age. Therefore, assuming a correlation of 1 is conservative in terms of the amount of information the marker score contributes to the blend, relative to the IMF % BV.
that on average, each star adds 0.37 AusMS units to an animal's true genetic merit for Marbling at commercial slaughter (AusMS). This was based on the analysis described in above.
that the genetic correlation between Genestar marbling star score and AusMS is 0.4, in other words, the Genestar marbling markers explains 0.4²=0.16 of the genetic variance in AusMS in commercial cattle. This was based on the analysis described in above.
that the genetic correlation between Genestar marbling star score and IMF % (as per the Breedplan EBV trait) of 0.4, to correspond with the assumption immediately above. In other words, the marker is likely to be equally as good at predicting the Breedplan EBV trait as it is at predicting AusMS.
that the heritability of IMF % (BV trait) equals 0.2 based on literature (Angus bulls) Reverter, A, and Johnston, D. J. (2001). Genetic analyses of live animal ultrasound and abattoir carcase traits in Angus and Hereford cattle. Proceedings of the Association for the Advancement of Animal Breeding and genetics Vol 14 pp 159-162.
that the heritability of Aus MS equals 0.4 based on literature Barwick, S. A. and Henzell, A. L. (1999). Assessing the value of improved marbling in beef breeding objectives and selection. Australian Journal of Agricultural Research 50:503-512.
that the phenotypic standard deviation of IMF % equals 1 based on literature Kahi, A. K., Barwick, S. A. and Graser, H-U (2003). Economic evaluation of Hereford cattle breeding schemes incorporating direct and indirect measures of feed intake. Australian Journal of Agricultural research 2003 54:1039-1055
that the phenotypic standard deviation of Aus MS equals 0.9 based on literature
   Barwick, S. A. and Henzell, A. L. (1999). Assessing the value of improved marbling in beef breeding objectives and selection. Australian Journal of Agricultural Research 50:503-512.

iii. Example Predictions of Blended Breeding Values for Sample Bulls

The table below shows some example predictions of blended breeding values for three bulls. For a group of 130 bulls with IMF % BVs and Genestar marbling star ratings, the correlation between the IMF % BVs and the Blended BVs was 0.76, while the correlation between the Genestar score and the blended BVs was 0.68.

| | IMF % | | | | Blended | Blend |
|---|---|---|---|---|---|---|
| Bull | BV | Accuracy | Stars | Genestar score | BV | accuracy |
| 1 | 1.3 | 58 | 2 | 0.333 | 1.49 | 68 |
| 2 | 1.4 | 61 | 3 | 0.703 | 1.94 | 70 |
| 3 | 1.3 | 60 | 0 | −0.407 | 0.78 | 69 |

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

What is claimed is:

1. A method of generating a genetic trait predictor comprising:
generating individual molecular estimates; and
blending said individual molecular estimates with estimates of at least one genetic value derived from a quantitative trait measure wherein said genetic trait predictor is correlated to a trait measured by said quantitative trait measure.

2. The method of claim 1, wherein said quantitative trait measure includes estimated breeding values.

3. The method of claim 1, wherein said quantitative trait measure includes raw trait data generated by field observations reproductive status or animal behavior, color and conformation; weight or length of an organism or parts of an organism at various times; body composition measures such as lean, fat distribution determined by scanning with sound (ultra-sound) or electromagnetic radiation or direct measurement; assays of immune or metabolic or gene expression status taken from tissues samples; meat quality measures taken mechanically, such as shear force, chemically such as fat composition, or by consumer taste panels.

4. The method of claim 1, wherein said quantitative trait measure includes breed composition data.

5. The method of claim 1, wherein said quantitative trait measure includes a combination of at least two of estimated breeding values, raw trait data, and breed composition data.

6. The method of claim 1, wherein said individual molecular estimates is generated by analysis of reference datasets from a population of animals or plants.

7. The method of claim 6, wherein said analysis generates derived parameters for individual deoxyribonucleic acid (DNA) markers or DNA marker panels describing a decay or a change of marker effects on specific traits with genetic distance.

8. The method of claim 7, wherein said individual molecular estimates are generated by determination of breed type.

9. The method of claim 7, wherein said individual molecular estimates are generated by determination of genetic distance between a test sample and said reference datasets.

10. The method of claim 9, further comprising deriving a specific parameter estimate and specific parameter variance for each of said individual DNA markers and said DNA marker panels for said test sample.

11. The method of claim 10, wherein said derivation of said specific parameter estimate employs a genetic distance between said test sample and said reference dataset.

12. The method of claim 10, wherein said derivation of said specific parameter estimate employs said parameters for said individual DNA markers or said DNA marker panels.

13. The method of claim 10, wherein said derivation of said specific parameter estimate employs a genetic distance between said test sample and said reference dataset and said parameters for said individual DNA markers or said DNA marker panels.

14. The method of claim 13, further comprising determining said estimates of at least one said genetic value, wherein said estimates of at least one said genetic value includes at least one of molecular trait estimates and molecular trait variance.

15. The method of claim 14, wherein said molecular trait estimates are determined by applying at least one of said individual DNA markers, said specific parameter estimate, and a genotype of said test sample.

16. The method of claim 14, wherein said molecular trait variance is determined by applying at least one of said individual DNA markers, said specific parameter estimate, and a genotype of said test sample.

17. The method of claim 14, wherein said molecular trait estimates are determined by applying said individual DNA markers, said specific parameter estimate, and a genotype of said test sample.

18. The method of claim 14, wherein said quantitative trait measure includes at least one of estimated breeding values, raw trait data, and breed composition data.

19. The method of claim 18, wherein said quantitative trait measure includes a combination of at least two of said estimated breeding values, said raw trait data, and said breed composition data.

20. The method of claim 19, wherein said quantitative trait measure includes said estimated breeding values, said raw trait data, and said breed composition data.

21. The method of claim 19, wherein said breed composition data is derived from visual information, pedigree information, or DNA marker information.

22. A method of generating a genetic trait predictor comprising:
generating individual molecular estimates; and
blending said individual molecular estimates with estimates of at least one genetic value derived from a quantitative trait measure, wherein said individual molecular estimates are generated by analysis of reference datasets from a population of animals or plants and wherein said analysis generates derived parameters for individual deoxyribonucleic acid (DNA) markers or DNA marker panels describing a decay or a change of marker effects on specific traits with genetic distance, wherein said individual molecular estimates are generated by determination of breed type and wherein said individual molecular estimates are generated by correlation of genetic distance between a test sample and said reference datasets.

23. A method of generating a genetic trait predictor comprising:
generating individual molecular estimates; and
blending said individual molecular estimates with estimates of at least one genetic value derived from a quantitative trait measure, wherein said individual molecular estimates are generated by analysis of reference datasets from a population of animals or plants and wherein said analysis generates derived parameters for individual deoxyribonucleic acid (DNA) markers or DNA marker panels describing a decay or a change of marker effects on specific traits with genetic distance, wherein said individual molecular estimates are generated by determination of breed type and wherein said individual molecular estimates are generated by correlation of breed type between a test sample and said reference datasets.
